(19) United States
(12) Patent Application Publication
(10) Pub. No.: US 2020/0264418 A1
(43) Pub. Date: Aug. 20, 2020

(54) METHOD OF CREATING A MULTI-PLANAR IMAGE BY USING VARIFOCAL LENSES AND A DEVICE TO REALIZE THIS METHOD

(71) Applicant: UNIWERSYTET IM. ADAMA MICKIEWICZA W POZNANIU, Poznan (PL)

(72) Inventor: Krzysztof DOBEK, Poznan (PL)

(21) Appl. No.: 16/641,555

(22) PCT Filed: Aug. 28, 2018
(86) PCT No.: PCT/PL2018/000082

§ 371 Date: Feb. 24, 2020

(30) Foreign Application Priority Data
Sep. 13, 2017 (PL) P.422851

(51) Int. Cl. G02B 21/02; G02B 21/36

(52) U.S. Cl. CPC G02B 21/025; G02B 21/361

(57) ABSTRACT

A multi-planar image creation device containing a laser light source mounted on a holder sliding in two perpendicular directions, an optical element combining imaged light and the laser light, an active GRIN plate, i.e. a device where a refractive index gradient can be formed dynamically by heat deposited with the laser light, a laser-impermeable filter; the active GRIN plate is mounted in such a way that the laser beam falls on it perpendicularly and behind the active GRIN plate is a filter absorbing the light of the laser beam through the optical element. The laser beam forms an active GRIN lens with a diameter smaller than the aperture of the optical system. Therefore, effectively a variable bifocal lens is created which can be used to image multiple planes in the sample simultaneously.

The subject of the invention is a method of creating a multi-planar image by using varifocal lenses and a device to realize this method, having application in the optical industry.

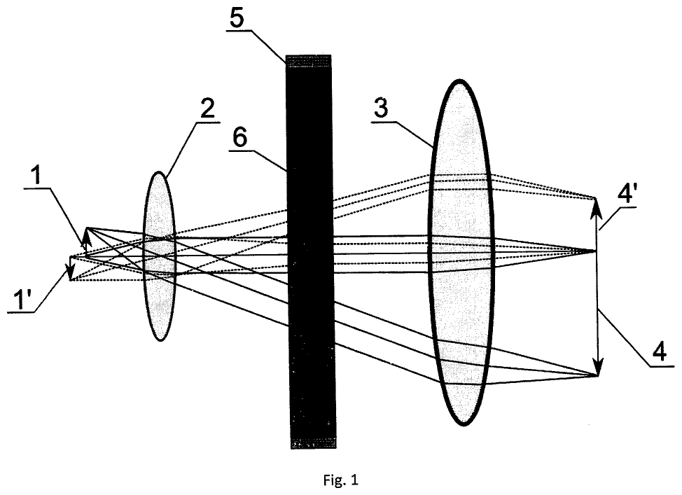

Due to the growing need for new technologies, a number of different solutions have been proposed to overcome the limitation of the classic lens—its fixed focal length, f. One of them is the artificial elastic intraocular lens, which was discussed in the NuLens® intraocular lens publication, NuLens Ltd. Herzliya, Israel, US patent 20070244561 A1. The shape of the lens is changed by the pressure of the muscles of the human eye. Another are polymer lenses with variable focal lengths, operating on the basis of deformation of the elastic refracting surface of the lens by changing the pressure of a liquid, which this surface closes, as presented in Chen J., Wang W., Fang J., Varahramyan K. “Variable-focusing microlens with microfluidic chip” J. Micromech Microeng. 14 (2004) 675-680. b) Agarwal M., Gunasekaran R. A., Coane P., Varahramyan K. “Polymer-based variable focal length microlens system” J. Micromech. Microeng. 14 (2004) 1665-1673. c) Zhang D.-Y., Lien V., Berdichevsky Y., Choi J., Lo Y.-H. “Fluidic adaptive lens with high focal length tenability” Appl. Phys. Lett. 82 (2003) 3171-3172, or by mechanical deformation of one of the polymeric surfaces of the lens, as described in Wiśniewska B., Wiśniewski W. “An optical element with variable properties and a method of producing an optical element with variable properties” patent PL 19197961. Also developed are electrostatic-based liquid-focus lenses whose shape is changed by applying an appropriate voltage between two electrodes illustrated in Kwon S., Lee L. P. “Focal Length Control by Microfabricated Planar Electrodes-based Liquid Lens (μPELL)” Proc. 11^{th} Int. Conf. Solid State Sens. Act. Trans. 1342 (2001) 1348-1351, Berge B. “Liquid lens technology: principle of electrowetting based lenses and applications to imaging” Proc. 18th IEEE Int. Conf. Mic. Elec. Mech. Syst. 2005, 227-230, Cheng C. C., Chang C. A., Yeh J. A. “Variable focus dielectric liquid droplet lens” Opt. Express 14 (2006) 4101-4106.
All of the above-mentioned techniques are based on changing the shape of the lens, which leads to a change of its focal length. Therefore, the ability to focus these lenses results from their shape, modifying the optical path of light. Other than the optical elements having a surface that refracts the light rays, the ability to focus or diffuse light is also demonstrated by a medium in the shape of, for example, a cube, in which a properly formed refractive index distribution occurs, ∇n. Optical elements of this type of ∇n distribution, are named GRIN (gradient refractive index) elements, and are produced as lenses or optical fibers, However, openly available gradient optical elements have their ∇n distribution already established during their production. Therefore, they can not provide variable focal length. All of their optical properties are rigidly set, just like with classic lenses made from glass or polymer. The ∇n distribution can, however, be produced temporarily in an optically uniform, homogeneous material. This goal can be attained in at least three types of materials. (1) The first of them is a material with thermo-optical properties. The absorption of laser beams causes a local heating of the material. The heterogeneity of the laser beam's intensity over its cross-section, along with the penetration of light into the material, decreases the intensity of the laser beam and exchange of heat overlapping between areas of material at different temperatures leads to the formation of thermo-optical material of non-uniforme temperature distribution. This distribution results in a heterogeneous distribution of the ∇n refractive index. This phenomenon is called thermal focusing, and the lens formed in this manner is referred to as a thermal lens. (2) The second type of material with which a laser beam may create a ∇n refractive index distribution is a photorefractive material. The laser beam produces, in the photorefractory material, a permanent or temporary change in the electric charge distribution, which results in the creation of a local electrical field modifying the refractive index of the material by the electro-optical effect, leading to the formation of ∇n distribution. (3) The third kind of material, in which a laser beam may produce refractive index distribution is a polymeric photosensitive material, as used in Angelini, A., Pirani, F., Frascella, F., Ricciardi, S., Descrovi, E. “Light-driven liquid microlens” Proc. of SPIE 10106, 1010610 (2017). It is composed of polymer molecules suspended in a liquid, whose conformation is modified due to laser beam photon absorption. Change of conformation leads to a change in density, and this to the distribution of the index of refraction, ∇n. In general, the laser beam can also trigger the emergence of electrostrictive forces, the Kerr optical effect or the electrocarolific effect leading to the ∇n distribution, which was discussed in Kielich S. “Molecular nonlinear optics” PWN, Warszawa-Poznari, 1977. The current state of the art indicates that materials of type (1) and (3) are better suited to create lenses induced by a laser beam. In each case in which the ∇n distribution created with a laser beam gives the light a phase delay analogous to that of a traditional lens, an optical element in which such a ∇n distribution is present it called a lens. The material in which such a lens can be made will be hereinafter referred to as AGRIN material (active GRIN), and the lens created in such material by laser beam illumination will be hereinafter referred to as an AGRIN lens.
The AGRIN lens can be created with a laser beam propagating in a direction parallel to the optical axis of the optical system, of which the AGRIN lens is a subassembly, or in a direction transverse to that axis. In the first case, the AGRIN lens may have axial symmetry with respect to the optical axis of the system of which the lens is a subassembly. In the second case, the AGRIN lens does not show such symmetry, and can function in the optical system of which it is a subassembly, as a cylindrical lens.
The previous considerations regarding the applicability of AGRIN lenses in imaging concerned the optical axis of the system whose lens was a subassembly. In all such considerations, the cross-section of the optical axis of the system measured for the AGRIN element used and the cross-section of the laser beam forming the AGRIN lens in this material had diameters greater than the aperture of the entire optical system containing the AGRIN lens itself. FIG. 1 presents a simplified schematic of the optical system shown in Angelini, A., Pirani, F., Frascella, F., Ricciardi, S., Descrovi, E. “Light-driven liquid microlens” Proc. of SPIE 10106, 1010610 (2017). It is a microscope with a lens 2 that creates an image of the object of observation 1 in infinity. Without the presence of the AGRIN lens 6, the image is then transformed by the eyepiece 3 into an image 4 formed in the image plane at a finite distance from the imaging plane of the main eyepiece. For the clarity of description of FIG. 1, no aberrations of the optical system are included. Similarly, the course of rays illustrated in FIG. 1 does not have to match the course imposed by the shape of the schematically illustrated lenses, and is for demonstrative purposes only. The presence of the AGRIN material in the form of the AGRIN plate 5, in which the AGRIN diffuser 6 is formed, with a section clearly larger than the aperture of the system, allowing to create a 4′ image in the same image plane in which the image 4 is created without the AGRIN lens 6 being present, wherein picture 4′ corresponds to object 1′ in a different object plane than object 1. The AGRIN lens 6 is coaxial with the lens and eyepiece, and modifies the direction of all light rays passing through the optical system of the microscope. This means that the presence of the AGRIN lens changes the objective plane of the microscope.

By using the solution according to the invention, the following technical effects have been obtained:
the possibility of obtaining, in the same image plane of the optical system provided with a solution, a sharp image of two (or more) objects in two (or more) different object planes, the distance separating these planes, measured in the direction of the optical axis of the system, exceed the distance corresponding to the maximum depth of field of the optical system provided in the solution, while these objects must not cover each other,
the ability to automatically adjust the focal length of the AGRIN lens(-es) as an integral part of the solution and automatically change the position of the same AGRIN lens(-es) to automatically obtain a sharp image of two (or more) objects, of which one (or more) are in motion while observing the sharp image of one (or more) immobile object(s), wherein the movable and immovable objects may be in different planes of the object's optical system provided with the solution, spaced from each other by a distance exceeding that which corresponds to the depth of field of the optical system provided with the solution, while these items can not cover each other,
the ability to focus the light of a single laser beam in one or several different points of the image space of the optical element constituting the solution, wherein the position of these points can be changed continuously in both the optical axis direction of the element forming the solution and in a direction perpendicular to the optical axis,
the ability to focus the light of multiple laser beams in various points of the image space of the optical element constituting the solution, wherein the position of these points can be changed continuously in the direction of the optical axis of the element.

The essence of the invention is an image forming method using the multiplane varifocal lens, characterized in that the beam of light rays coming from any light source is directed to the observed object, which reflects or transmits part of these light rays through which at least one of the dispersion or focusing AGR1Ns and at least one focusing lens of classical or AGRIN type are placed, in such a way that light rays reflected from or passing through a part of the observed object pass through the AGRIN lens, and the light rays reflected from or passing through the remaining part of the object of observation do not pass through the AGRIN lens, however, they pass through the AGRIN plate in the region of homogeneous ∇n refraction index, with all of the rays that pass through the AGRIN plate having passed previously, or passed through at least one classical or AGRIN type focusing lens, and as a result of which, the rays from the observed object that pass the AGRIN lens form a sharp image of the part of the observed object at a different imaging distance measured from the second plane of the main AGRIN lens, and the rays from the observed object do not obscure the AGRIN lens, and they form a sharp image of a fragment of the observed object at the same image distance measured from the second plane of the main AGRIN lens, in which the image of the second observed object appears, located in a different plane than the observed object, all light rays that pass through the optical system used for imaging pass through the AGRIN lens, which then participate in creating a sharp image of the observed object in one image plane, identical to the plane in which a sharp image of a part of the observed object was created, after placing the next AGRIN lens in the AGRIN plate with a properly selected focal length, all light rays reflected from, or passing through, a fragment of another observed object that passes through the optical system used for imaging and passes through the AGRIN lens form an image of this part of the observed object at the same imaging distance measured from the second plane of the main AGRIN lens, in which the image of the object and a part of the object is created.

It is advantageous if the AGRIN diffuser lens is used when the observed object is located at an observation distance greater than the observed object.

It is also advantageous if the AGRIN focusing lens is used when the observed object is located at an observation distance smaller than the observed object.

On top of that, it is advantageous if the light rays reflected from or passing through the observed objects before passing through the AGRIN plate in which the AGRIN lens is formed, additionally pass through further optical elements that perform the functions of at least one classic or AGRIN focusing lens.

It is also advantageous if the light rays passing through the AGRIN plate in which the AGRIN lens is formed additionally pass through further optical elements that perform the functions of at least one classic or AGRIN focusing lens.

Furthermore, it is advantageous if the light rays reflected from or passing through the observed objects before passing through the AGR1N plate in which the AGRIN lens is formed additionally pass through consecutive optical elements performing functions of at least one classic or AGRIN focused lens, while the light rays passing through the AGRIN plate in which the AGRIN lens is created, after passing through the AGRIN plate, additionally pass through successive optical elements, performing the functions of at least one classic or AGRIN focusing lens.

A multifaceted image creation device using a varifocal lens containing a laser light source, a holder sliding in two perpendicular directions, an optical element transmitting imaged light over a wide spectral range and reflecting laser light, an AGRIN plate, a laser-impermeable filter and a housing holding the components at fixed mutual distances, characterized in that the laser light source is a fiber optic collimator connected to an external laser, which is mounted in a sliding holder operating in two directions perpendicular to the direction of the laser beam coming out of the laser light source, which is fixed to the sliding holder with a clamp, the optical element is located in the housing in such a way that it transmits the imaged light beam and reflects the laser beam, and the AGR1N plate is mounted in the housing in such a way that the laser beam falls on it perpendicularly and behind the AGRIN plate, located in the housing, is a filter absorbing the light of the laser beam through the optical element.

It is advantageous if the laser light source is a diode laser.

It is also advantageous when an additional source of laser light is located in the housing, being a fiber optic collimator connected to an external laser, which is mounted in a sliding handle, operating in two directions, perpendicular to the direction of the laser beam leaving the laser light source, which is attached to the sliding handle with a clamp, whereas the optical element, mounted in the housing, transmits the laser beam and reflects the laser beam directing both beams parallel to the optical element, and the part of the light which is directed at a right angle by the optical element relative to the beam directed to the optical element is absorbed by the housing element.

It is advantageous if the laser light source is a diode laser.

It is also advantageous when the optical element is a dichroic mirror or polarizing cube.

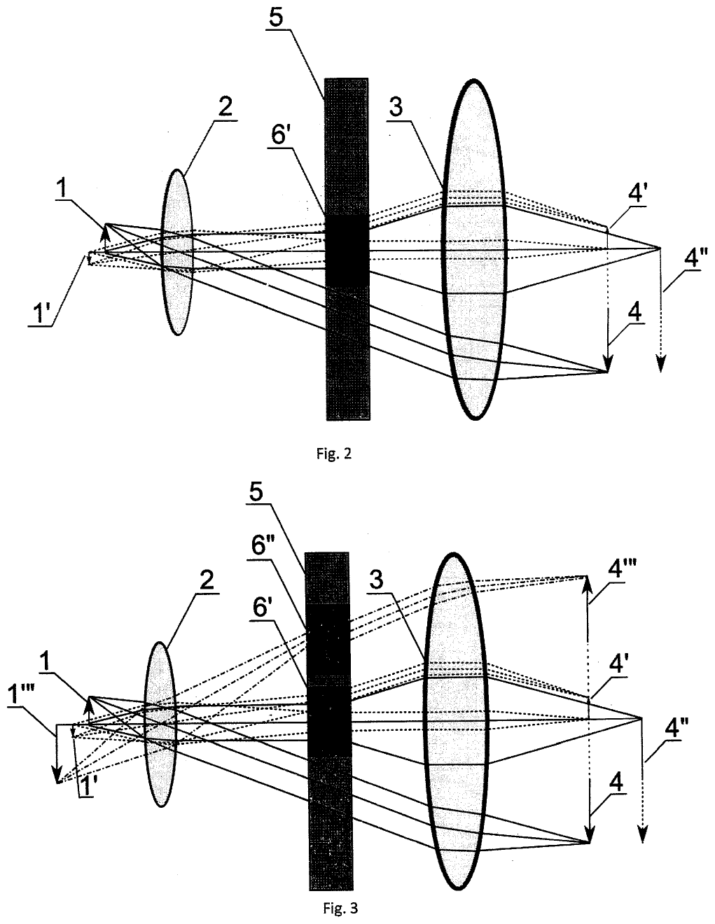

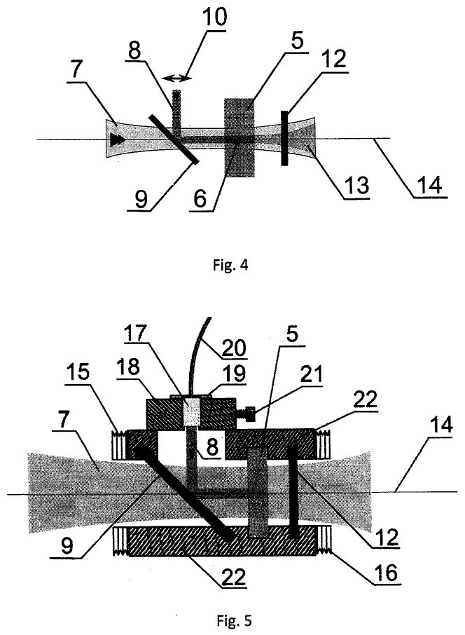

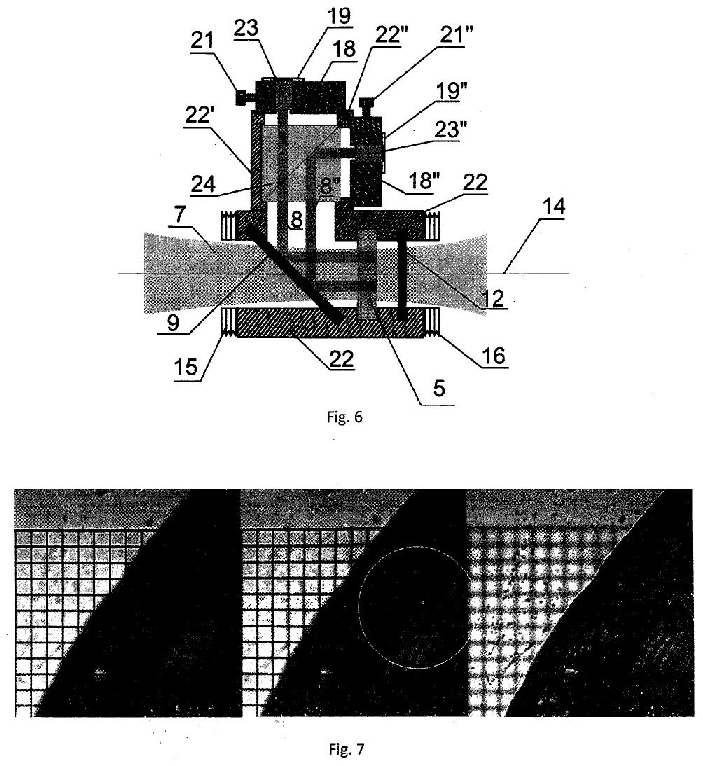

The invention, in an exemplary but non-limiting embodiment, has been presented in the drawings where FIG. 1 presents a simplified schematic of the optical system shown in Angelini, A., Pirani, F., Frascella, F., Ricciardi, S., Descrovi, E. “Light-driven liquid microlens” Proc. of SPIE 10106, 1010610 2017, FIG. 2 presents the optical system with a single AGRIN lens, FIG. 3 illustrates variants of the invention with the use of two AGRIN lenses, FIG. 4 schematically illustrates the method of creating AGRIN 6′ lenses in the AGRIN 5 plate, FIG. 5 presents a solution with the use of one laser beam; on FIG. 6 a solution using small lasers as a two-laser beam source, and FIG. 7 presents an example photo of the resulting image.

FIG. 2 schematically presents the optical system with a single AGRIN lens. This system is composed of three featured components of the entire set of optical elements forming the imaging system. These are the optical elements forming the subset 2, the AGRIN plate 5 and subset 3 of optical elements. If it is assumed that a human eye lens or camera is not part of subassembly 3, then, for general imaging, only the AGRIN plate 5, or AGRIN plate 5 and a subset of 2 optical elements, or AGRIN 5 plate and a subset of 3 optical elements or all three components shown as in FIG. 2 may be used. FIG. 2 shows a simplified microscope schematic including an AGRIN lens 6′ and a subset of 2 optical elements playing the role of a lens, while a subset of 3 optical elements plays the role of an eyepiece, and for simplicity, are both subsets illustrated as single lenses. In the AGRIN plate 5, an area with inhomogeneous refractive index distribution ∇n is produced with the help of a laser beam (not shown), playing the role of the AGRIN lens 6′ with a properly selected focal length. The AGRIN lens 6′ differs from the AGRIN lens 6 with a cross-sectioned diameter. in the case of the AGRIN lens 6′, this diameter is clearly smaller than the aperture of the optical system (e.g. the microscope), where the AGRIN lens is a subassembly. In FIG. 2 the AGRIN lens 6′ is coaxial with the optical axis of lens 2 and eyepiece 3 i.e. it lies in the optical axis of the system. It doesn't have to be this way. In general, it can be created by means of a laser beam in the non-axial area. FIG. 2 schematically illustrates the effect of the AGRIN lens 6′. FIG. 2 does not take into account any aberrations of the optical system. Similarly, the course of rays illustrated in FIG. 2 does not have to match the course imposed by the shape of the schematically illustrated lenses, and is for demonstrative purposes only. In FIG. 2 there are two imaging objects illustrated. Two types of rays leave Object 1: a beam of aperture rays and a beam of field rays. Aperture rays pass through the AGRIN lens 6′. Half-rays pass through the AGRIN plate 5 but in the area with a homogeneous distribution of the ∇n refractive index. Illustrated in FIG. 2 is the exemplary arrangement of the AGRIN 6′ scattering type lens. This happens when the inhomogeneous distribution of the ∇n refractive index corresponds to the smallest value of the n refractive index in the axis of the AGRIN lens, and the maximum on its edges. The aperture rays of object 1 are effectively deflected from the optical axis of the AGRIN lens. This results in the creation of image 4″ of the axial point of object 1 at a distance from the second plane of the main AGRIN 6′ lens greater than without the presence of AGRI N 6′ lenses. The half-ray of object 1 does not yield additional deflection and create image 4 of object 1 at a distance from the second plane of the main AGRIN lens 6′ smaller than in the presence of AGRIN lenses 6′. Object 1′ is located at a distance measured from the first plane to the main AGRIN lens 6′ greater than item 1. In effect, the lens creates an image of object Vat a finite picture distance. Object 1′ is, however, small enough that both the aperture rays and the half-rays, whose beams leave object 1′, pass through the AGRIN lens 6′. The AGRIN lens modifies the aperture and half-rays of object 1′ so that the image of object 1′ is again created in the infinity. As a result, the eyepiece creates a picture 4′ of the object 1′ in the same image plane of the eyepiece, in which there is picture 4 of object 1. It is possible to simultaneously observe sharp images 4 of a part of object 1 and 4′ of all of object 1′.

FIG. 3 illustrates a variant of the invention using two AGRIN lenses 6′ and 6″. In the AGRIN plate 5, an additional AGRIN lens 6″ with an appropriate focal length is produced by means of an additional laser beam. The beam of the field rays leaving the portion of the additional observed object 1″ passing through the AGRIN 6″ lens is formed in such a way that it forms a 4′″ image of the observed object 1″ at the same distance from the second plane of the AGRIN 6′ main lens in which an image of object 1′ and a part of the observed object 1 is formed. As a result, in the same plane of observation, an image of three observed objects lying in different planes is created.

FIG. 4 schematically illustrates the method of creating AGRIN lenses 6′ in the AGRIN plate 5. The rays of imaged objects 1 and 1′ create an imaged light beam 7. The arrow on the illustration of this beam shows the direction of propagation from the object to the image. The laser beam 8 of wavelength, Maser, selected for the AGRIN material of AGRIN 5 is directed by means of a shifting system 10 acting in any manner towards the optical element 9 transmitting light beam 7, which then reflects laser beam 8. On the illustration, the laser beam has an arrow showing the direction of the laser beam propagation. Optical element 9 could be e.g. a dichroic mirror, polarizing cube or any other optical element fulfilling the above condition of reflecting beam 8 and transmitting beam 7. Reflected from element 9, the laser beam moves parallel to the optical axis of system 14 and falls on an AGRIN plate 5 made out of AGRIN material, in which it forms an AGRIN lens 6′. Behind the AGRIN plate 5 the filter 12 is located, which does not transmit light of the wavelength of laser beam 8, λₗₐₛₑᵣ, of which a part can pass through the AGRIN plate 5, while filter 12 transmits light on a different length than the light length of laser beam 8. The presence of filter 12 is not necessary, if the range of intensity of laser beam 8 and the optical properties of AGRIN plate 5 (e.g. the transmission coefficient for the wavelength of λₗₐₛₑᵣ) are chosen so that for any intensity of laser beam 8, the light of the laser beam does not pass through the AGRIN plate 5. The illustrated example AGRIN lens 6′ on FIG. 4 is of a diverging type and makes part 13 of the beam imaged by the system, and passing through the AGRIN 6′ lens more divergent/less convergent with respect to beam 7 entering the AGRIN plate 5.

The proper selection of the wavelength, λₗₐₛₑᵣ, of laser beam 8 to the AGRIN material of the AGRIN plate 5 means that it is absorbed by the AGRIN material and leads to the ∇n refractive index distribution inside the AGRIN material, according to the mechanisms previously described.

The invention, in exemplary embodiment, is presented in FIGS. 5 and 6, where FIG. 5 shows the solution with the use of one laser beam 8 being delivered to the system with the help of optic fiber 20 and fiber optic collimator 17. The fiber optic collimator 17 is mounted on sliding handle 18, operating in two directions, perpendicular to the direction of travel of laser beam 8 leaving fiber optic collimator 17. FIG. 5 illustrates the possibility of moving collimator 17 in only one direction parallel to the optical axis of system 14, and the displacement can be made possible by means of e.g. a hand-held micrometer screw 21 or a motorized, electronically controlled screw. Fiber optic collimator 17 is fastened to sliding handle 18 by clamp 19. The light of laser beam 8 that is emitted by fiber optic collimator 18 is directed in the direction of optical element 9 transmitting the light beam of image 7 and reflecting laser beam 8, e.g. on a dichroic mirror. Next, the laser beam falls on the AGRIN plate 5. Behind the AGRIN plate 5, the remaining light from laser beam 8 is absorbed by filter 12. Optical element 9, AGRIN plate 5 and filter 12 are fastened to the optical system housing 22. Housing 22, 22′ and 22″ of optical systems, as illustrated on FIGS. 5 and 6 may be an integral part of the housing of a larger optical system, as illustrated in FIG. 2, or the housing of optical systems illustrated in FIGS. 5 and 6 may be finished with elements allowing for the connection of these systems with other optical systems e.g. with the help of threads 15 and 16. For example, in the arrangement illustrated in FIG. 2, thread 15 serves to connect the optical systems illustrated in FIGS. 5 and 6 with optical element 2, and thread 16 serves to connect the optical systems illustrated in FIGS. 5 and 6 with optical element 3. FIG. 6 presents the solution with the use of two laser beams, that can form two individual lenses, AGRIN 6′ and AGRIN 6″ in the AGRIN plate 5. FIG. 6 presents the solution using small 23 and 23″ lasers, e.g. diode, as a source of two 8 and 8″ laser beams. For illustrative purposes, they are shown offset relative to sliding handles 18 and 18″, in which lasers 23 and 23″ are attached. Lasers 23 and 23″ are moved with screws 21 and 21″. The beams emitted by lasers 23 and 23″ are directed to optical element 24 which transmits the laser beam falling on it in a direction perpendicular to the optical axis of system 14 and reflects the laser beam at a right angle in a direction parallel to the optical axis of system 14. The role of such an element can play as a polarizing light-dividing cube. Assuming that the beam of both lasers is polarized in the right way, the cube can direct laser beams 23 and 23″ towards optical element 9 with a yield of nearly 100%. The other elements of the system illustrated in FIG. 6 play the same role as their counterparts in FIG. 5. They differ in the presence of housing part 22, as highlighted in FIG. 6. In the case where element 24 directs a part of the light of laser beams 23 and 23″ towards housing 22′, e.g. when its role is played by a normal light-dividing cube, then housing 22′ should absorb it and the resulting heat should be returned to the environment, e.g. using a radiator. FIG. 7 presents three photos from a prepared publication presenting the final effect of the operation of a local laser-induced lens. On the left side, a microscope scale image is visible, with an elementary scale spacing of 50 μm, and underneath, samples of a pumpkin stem cross-section, with the microscope lens focus set on the scale. On the right side, the same image is visible, but with the focus set on the cross section of the pumpkin stem. In the middle, the same pair of samples is visible with the active lens induced in the area of the marked circle. The presence of an induced lens causes the image of the pumpkin-stem cross-section to come into focus in the region subjected to an induced lens, and the scale is in focus in the remaining image area.

1. Image forming method using a multi-plane varifocal lens, characterized in that the beam of light rays coming from any light source is directed to observed object 1, which reflects or transmits part of these light rays, on the path of which at least one of diverging or converging type AGRIN lens 6′ and at least one converging lens of classical or AGRIN type are placed, in such a way that light rays reflected from or passed through a part of observed object 1 pass through the AGRIN lens 6′, and the light rays reflected or passed through the remaining part of the observed object 1 do not pass through the AGRIN lens 6′, however, they pass through the AGRIN plate 5 in the region of homogeneous ∇ [symbol] refraction index, with all of the rays that pass through the AGRIN plate 5 having passed through previously, or passing through at least one classical or AGRIN type converging lens, and as a result of which, the rays from the observed object 1 that passed through the AGRIN lens 6′ form a sharp image 4″ of the part of the observed object 1 at a different imaging distance measured from the second plane of the main AGRIN lens 6′, and the rays from the observed object 1 do not obscure the AGRIN lens 6′, and they form a sharp image of a fragment of the observed object at the same image distance measured from the second plane of the main AGRIN lens 6′, in which image 4′ of the second observed object 1′ appears, located in a different plane than the observed object 1′, all light rays that pass through the optical system used for imaging pass through the AGRIN lens 6′, which then participate in creating a sharp image 4′ of the observed object 1′ in one image plane, identical to the plane in which a sharp image 4 of a part of the observed object 1 was created, after placing the next AGRIN lens 6″ in the AGRIN plate 5 with a properly selected focal length, all light rays reflected from, or passing through, a fragment of another observed object 1′″ that passes through the optical system used for imaging and passes through the AGRIN lens 6″ form an image of this part of the observed object 1′″ at the same imaging distance measured from the second plane of the main AGRIN lens 6′, in which the image of the object and a part of object 1 is created.

2. An image forming method according to claim 1, characterized in that the diverging AGRIN lens 6′, is used when the observed object 1′ is located at a greater distance than the observed object 1.

3. An image forming method, according to claim 1, characterized in that the converging AGRIN lens 6′ is used when the observed object 1′ is located at a lesser distance than the observed object 1.

4. An image forming method according to claim 1, characterized in that the light rays reflected or passed through the observed objects 1 and 1′ before passing through the AGRIN plate 5 in which the AGRIN lens 6′ is formed, additionally pass through successive optical elements 2, which act as at least one classic or AGRIN converging lens.

5. An image forming method according to claim 1, characterized in that the light rays passing through the AGRIN plate 5 in which the AGRIN lens 6′ is formed additionally pass through successive optical elements 3, which act as at least one classic or AGRIN converging lens.

6. An image forming method according to claim 1, characterized in that the light rays reflected or passed through the observed objects 1 and 1′ before passing through the AGRIN plate 5 in which the AGRIN lens 6′ is formed, additionally pass through the optical elements 2, which act as at least one classic or AGRIN converging lens, while the light rays passing through the AGRIN plate 5 in which the AGRIN lens 6′ is formed, after passing through the AGRIN plate 5 further pass through successive optical elements 3, which act as at least one classic or AGRIN converging lens.

7. A multi-planar image creation device using a varifocal lens containing a laser light source, a holder sliding in two perpendicular directions, an optical element transmitting imaged light over a wide spectral range, and reflecting laser light, an AGRIN plate, a laser-impermeable filter and a housing holding the components at fixed mutual distances, characterized in that the laser light source is a fiber optic collimator 17 connected to an external laser, which is mounted in a sliding holder 18 operating in two directions perpendicular to the direction of the laser beam 8 coming out of the laser light source, which is fixed to the sliding holder 18 with a clamp 19, an optical element 9 is located in the housing 22 in such a way that it transmits the imaged light beam 7 and reflects the laser beam 8, and the AGRIN plate 5 is mounted in the housing 22 in such a way that the laser beam 8 falls on it perpendicularly and behind the AGRIN plate 5, located in the housing 22, is a filter 12 absorbing the light of the laser beam 8 through the optical element 9.

8. A device according to claim 7, characterized in that the laser light source is a diode laser 23.

9. A device, according to claim 7, characterized in that an additional laser light source is provided in housing 22, being a fiber optic collimator 17″ connected to an external laser, which is mounted to sliding handle 18″ operating in two directions perpendicular to the direction of laser beam 8″ exiting the light source which is attached to sliding handle 18″ with a clamp 19″, whereas the optical element 24 mounted in housing 22′ and 22″, transmits the laser beam 8 and reflects the laser beam 8″, with both beams being parallel to the optical element 9, and the part of light which is directed at a right angle by optical element 24 will be directed at optical element 9 and absorbed by housing element 22′.

10. A device, according to claim 7, characterized in that the laser light source is a diode laser 23″.

11. A device, according to claim 7, characterized in that the optical element 9 is a dichroic mirror.

12. A device, according to claim 7, characterized in that optical element 9 is a polarizing cube.
